(19) United States
(12) Patent Application Publication
(10) Pub. No.: US 2008/0116012 A1
(43) Pub. Date: May 22, 2008

(54) Platform Lift for a Vehicle

(76) Inventor: Brock E. Ferguson, Cottage Grove, OR (US)

Correspondence Address: QUARLES & BRADY LLP, 411 E. WISCONSIN AVENUE, SUITE 2040, MILWAUKEE, WI, 53202-4497, US

(21) Appl. No.: 11/937,759

(22) Filed: Nov. 9, 2007

Related U.S. Application Data
(60) Provisional application No. 60/865,096, filed on Nov. 9, 2006.

(51) Int. Cl. B66F 7/00

(52) U.S. Cl. 187/213

(57) ABSTRACT

A platform lift for a vehicle suitable for supporting and vertically moving platforms, beds, shelves and the like. The platform lift has at least a first platform suspended by a plurality of tension members, such as cables, and guided by a plurality of columns so that the first platform is movable vertically between a first platform stowed position and a first platform ready position. All of the columns supporting the platform are to one side of a center of the first platform. The platform lift includes a slack sensor and fall protection. The platform lift can include a second platform.

### CROSS-REFERENCE TO RELATED APPLICATIONS

This claims the benefit of U.S. Provisional Patent Application No. 60/865,096 filed Nov. 9, 2006.

### STATEMENT REGARDING FEDERALLY SPONSORED RESEARCH

Not applicable.

### BACKGROUND OF THE INVENTION

The present invention relates to recreational vehicles, and more particularly to lifting mechanisms for raising and lowering objects within the interiors of such vehicles.

In order to increase the available interior space of recreational vehicles or trailers, slide-out sections, such as rooms or closets, can be made integral with the structure of the vehicle or trailer. These slide-out sections usually include a floor, a roof, an end wall and one or more side walls. In the retracted position the roof, floor and side walls are typically inside the vehicle, concealed from exterior view, and the end wall forms a portion of the vehicle's exterior side wall. During transit, these sections are retracted and stored in the interior of the vehicle, with the exterior wall of the slide-out section being flush with the exterior of the vehicle. To use the slide-out section, the vehicle is first parked and leveled. The slide-out room is then slid outward from the vehicle, thereby increasing the interior space of the vehicle. Various drive assemblies exist to extend and retract the slide-out sections. These drive assemblies can be manual or powered, including hydraulics, pneumatics, electronics, simple gearing mechanisms, cable and pulley arrangements, or various combinations thereof. U.S. Pat. No. 6,254,171 discloses one type of operating mechanism for a slide-out room. Slide-out room assemblies can add prohibitive cost and weight to a vehicle such that other methods must be employed to increase interior seating and like space. Moreover, even if the vehicle is equipped with a slide-out room additional interior space may be desired in the slide-out room.

Another way to increase interior space in such vehicles is to change the vertical position of certain objects at the vehicle interior, such as furniture and other such items. The objects can be raised out of the way when not used, but otherwise lowered while being used. This allows floor space and living space to be cleared of unnecessary objects without eliminating the presence of those objects from within the vehicle.

In-vehicle lift mechanisms of the type that are mounted within the interior of a trailer or other vehicle for raising and lowering a platform are known. International Patent Application Publication No. WO2006/007522 describes one such lift mechanism, which is specially suited for raising and lowering furniture such as a bunk bed. U.S. Provisional Patent Application No. 60/806,359 filed Jun. 30, 2006 describes another such lift mechanism, which is specially suited for raising and lowering heavy loads. These applications are hereby incorporated by reference as if fully set forth herein for their disclosure of lift mechanisms.

In-vehicle lift mechanisms can free up floor space but can prevent wall space from being used because the support columns for the lift mechanisms are mounted to multiple walls and/or positioned near multiple walls. A need exists for a platform lift that allows for more usable wall space in the interior of the vehicle that allows more flexibility in the placement of windows, shelves, cabinets, furniture and the like.

### SUMMARY OF THE INVENTION

The present invention provides a platform lift for a vehicle, the platform lift comprising a first platform guided vertically by columns and suspended in at least one position along the columns by tension members so that the first platform is movable vertically between a first platform stowed position and a first platform ready position, the improvement wherein all of the columns supporting the platform are to one side of a center of the first platform.

The first platform can be supported in the stowed position with the tension members resisting the downward forces on the platform and the columns resisting the torsional forces. This may be the mode of support as the platform moves relative to the columns also. In the ready position, the platform may be fully supported by support members extending from the column outwardly to the platform and in tension to partially support the weight of the platform and by the columns resisting any remaining vertical forces acting on the platform. In the ready position, the columns preferably have stops that the platform rests on.

The first support member can be attached to the first one of the columns and to the first platform and a second support member can be attached to the second one of the columns and to the first platform. The support members can be cables, chains, sliding links or any member capable of supporting the platform in the ready position while permitting vertical movement between the stowed and ready positions.

The platform can also include a first truck and a second tuck, the first truck rolling along a first one of the columns and the second truck rolling along a second one of the columns, the first platform extending from the first and second trucks.

A plurality of notches can be formed within the first one of the columns and the first truck can include a fall protection assembly that is configured to engage at least one of the plurality of notches if one of the plurality of tension members goes slack between the stowed and ready positions.

The platform lift can also include a motor and at least one slack tension member sensor. The motor can be configured to cause the plurality of tension members to vertically move the first platform. The first slack sensor can monitor a slackness of at least one of the plurality of tension members. The first slack sensor can cause the motor to stop when the one of the plurality of tension members goes slack.

The platform lift can also include a second platform vertically movable between a second platform stowed position and a second platform ready position. The first platform can extend from a pair of first trucks and the second platform can extend from a pair of second trucks. The plurality of tension members can include a plurality of first truck catch members and a plurality of second truck catch members, the plurality of first truck catch members supporting the pair of first trucks when the first platform is positioned at a height above the first platform ready position and the plurality of second truck catch members supporting the pair of second trucks when the second platform is positioned at a height above the second platform ready position.

The platform lift can be configured so that the second platform does not support the first platform when the second platform is in the second platform stowed position.

The foregoing and other advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a platform lift with beds (in phantom) in a ready position;

FIG. 2 is a side view of a column of a platform lift with portions cutaway;

FIG. 3 is a side view of the column of FIG. 2 in the direction of line 3-3 of FIG. 2;

FIG. 4 is a sectional view taken along the line 4-4 of FIG. 2;

FIG. 5 is a side view a platform lift showing the platforms being lowered;

FIG. 6 is a view similar to FIG. 5 albeit showing the platforms being raised;

FIG. 7 is a view similar to FIG. 5 albeit showing the platforms in a stowed position;

FIG. 8 is a partial side view of a column of a platform lift with portions cutaway to show the fall protection assembly of the truck in an engaged position;

FIG. 9 is a view similar to FIG. 8 albeit showing the fall protection assembly in an unengaged position;

FIG. 10 is a side view of a column of a platform lift with portions cutaway to show a slack sensor sensing a taught condition of the tension member;

FIG. 11 is a view similar to FIG. 10 albeit showing a slack sensor sensing a slack condition of the cable;

FIG. 12 is a perspective view of a column of a platform lift;

FIG. 13 is a perspective view of another embodiment of a slack sensor;

FIG. 14 is a perspective view of a truck for a platform lift; and

FIG. 15 is an assembly view of a truck with brake for a platform lift.

### DETAILED DESCRIPTION OF THE PREFERRED EMBODIMENT

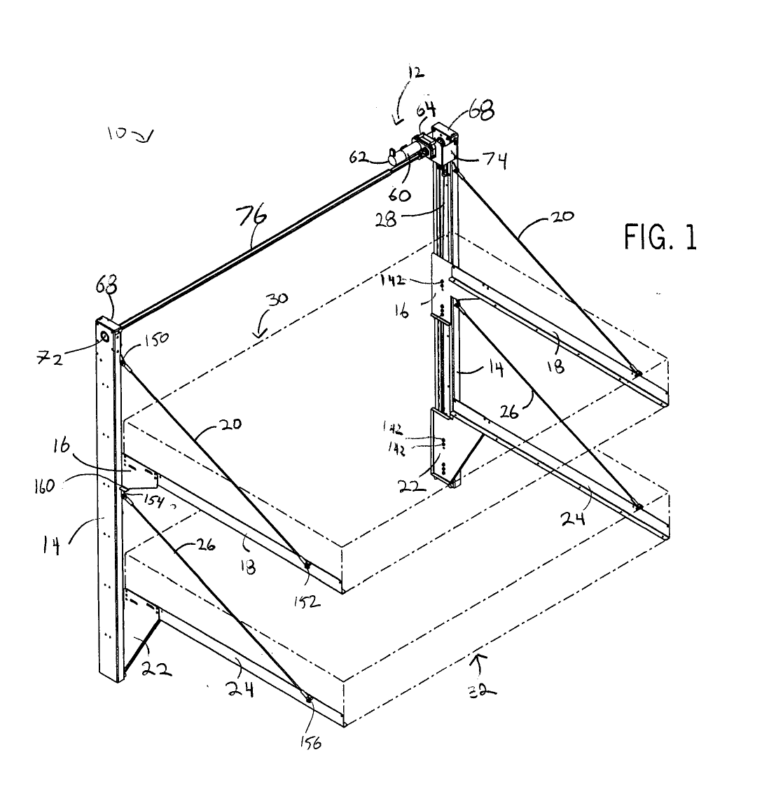

Although not shown in the drawings, the present invention is preferably used in a vehicle, such as a tow-along trailer or self-propelled (motorhome) recreational vehicle. Referring now to the drawings wherein like reference numbers correspond to similar components throughout the several views and, specifically, referring to FIG. 1, the present invention shall be described in the context of a platform lift 10. In addition to freeing up floor space in the interior of the vehicle, the platform lift's 10 frees up wall space in the interior of the vehicle.

Platform lift 10 can be mounted inside the main vehicle interior or within an extendable and retractable slide-out section of the vehicle to provide further space-saving benefits. Such slide-out sections are well known to have a floor, a ceiling, upright end wall and two upright side walls, which form a part of the vehicle exterior when extended. The platform lift 10 can support platforms, beds, shelves and the like.

Referring now to FIG. 1, platform lift 10 includes a drive assembly 12, columns 14, upper truck braces 16, upper support arms 18, upper support members 20, lower truck braces 22, support arms 24, lower support members 26 and cables 28. An upper platform 30 and a lower platform 32 (both shown in phantom) are supported by the platform lift 10 as will be discussed in hereinafter.

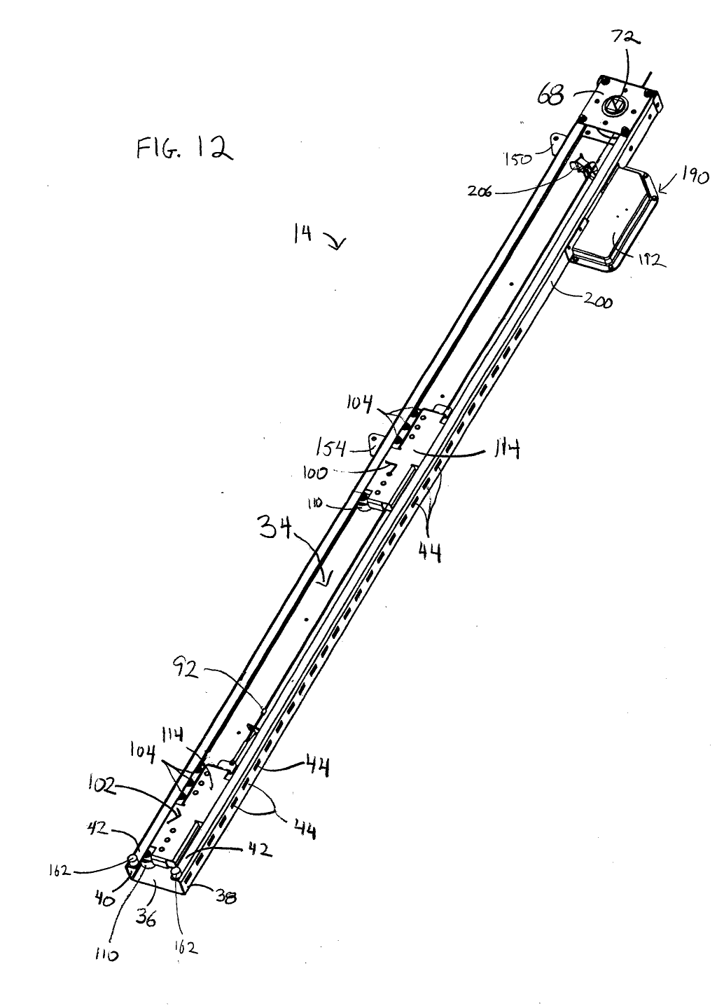

Referring now to FIGS. 1 and 12, each column 14 is a generally rectangular tube having an open face thereby forming a channel 34. Channels 34 are each defined by a channel back wall 36, a channel first side wall 38, a channel second side wall 40 and two rails 42. Columns 14 are arranged so that the channels 34 face towards each other and the channel back walls 36 are parallel. Rails 42 are formed on the open face of the column 14. A plurality of slots 44 are formed in the channel first side wall 38 of each column 14. The columns 14 are bolted, welded and or otherwise fixed to the same side wall, to adjacent side walls, to opposite sidewalls, to the floor and/or to the ceiling of the vehicle room. The top and bottom ends of these columns 14 may be either capped, have clearance or run full height of the room. “Feet” (not shown) at either the bottom, top or both ends of the columns 14 if the lift mechanism is mounted to the floor, ceiling or floor and ceiling, respectively. Each foot can be a solid steel piece or a stack of steel pieces that are disposed between the vertical channels and the flooring or joists or other structural parts of the floor and ceiling. Columns 14 can be fixed to the vehicle so as to allow for greater flexibility in the placement of windows, shelves, cabinets, furniture and the like

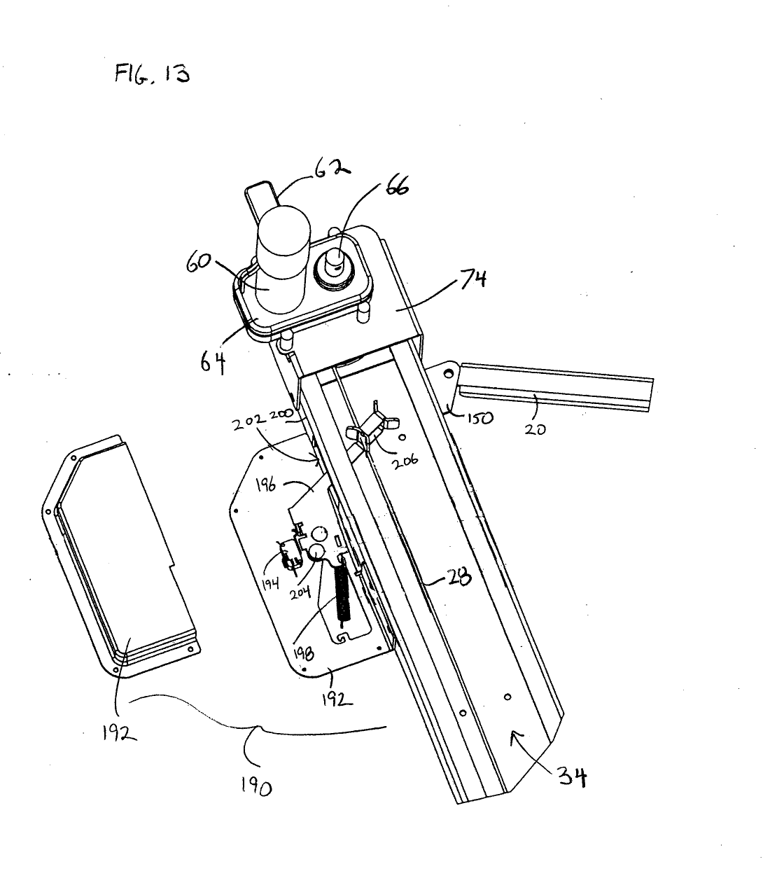

Referring now to FIGS. 1 and 13, the height adjustment of the platforms 30 and 32 is accomplished by actuating the drive assembly 12 to move the platforms as will be discussed hereinafter. Drive assembly 12 includes a suitable bidirectional electric motor brake 60 with a release mechanism 62 and a gear box drive unit 64. The motor brake's 60 output shaft is rotatably coupled to the gear box drive unit 64. When operation of motor brake 60 is stopped, its brake automatically and positively clamps the output shaft against further rotation. In case of a motor brake malfunction or a loss of power, the release mechanism 62 can be manually actuated to cause the release of the motor brake's 60 brake thereby allowing for the rotation of the motor brake's 60 output shaft. The gear box drive unit 64 includes a gear box output shaft 66 having two shaft ends that extend out of opposite sides of the gear box drive unit 64, the shaft ends may be square, round, or any other suitable shape or combination of shapes. The gear box drive unit 64 includes gears that transmit rotational motion from the motor brake 60 to the gear box output shaft 66 at an appropriate gear ratio.

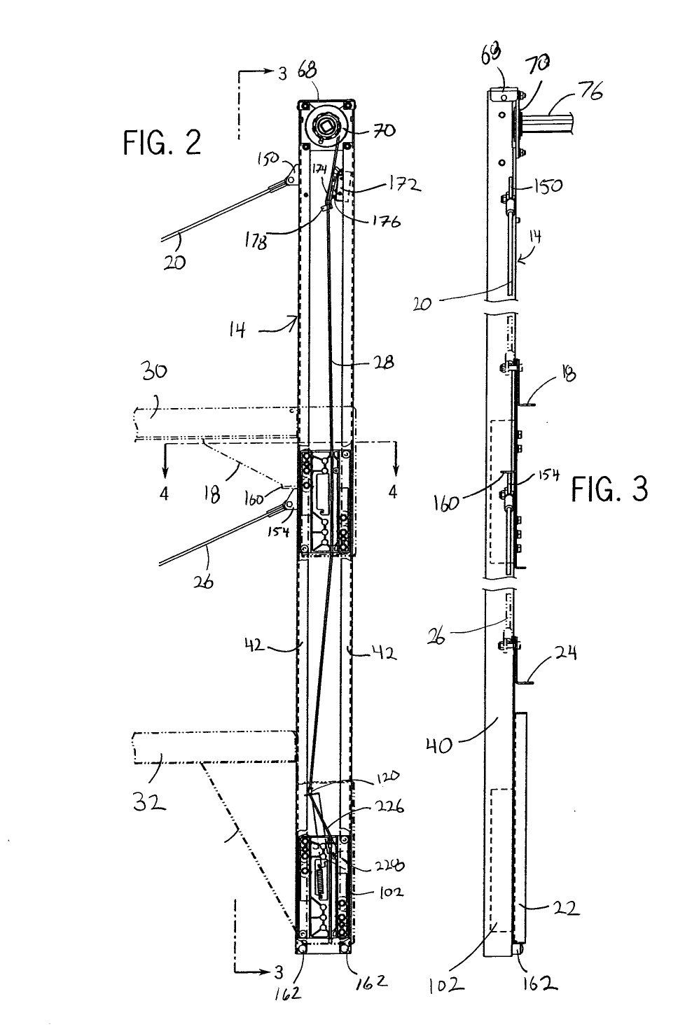

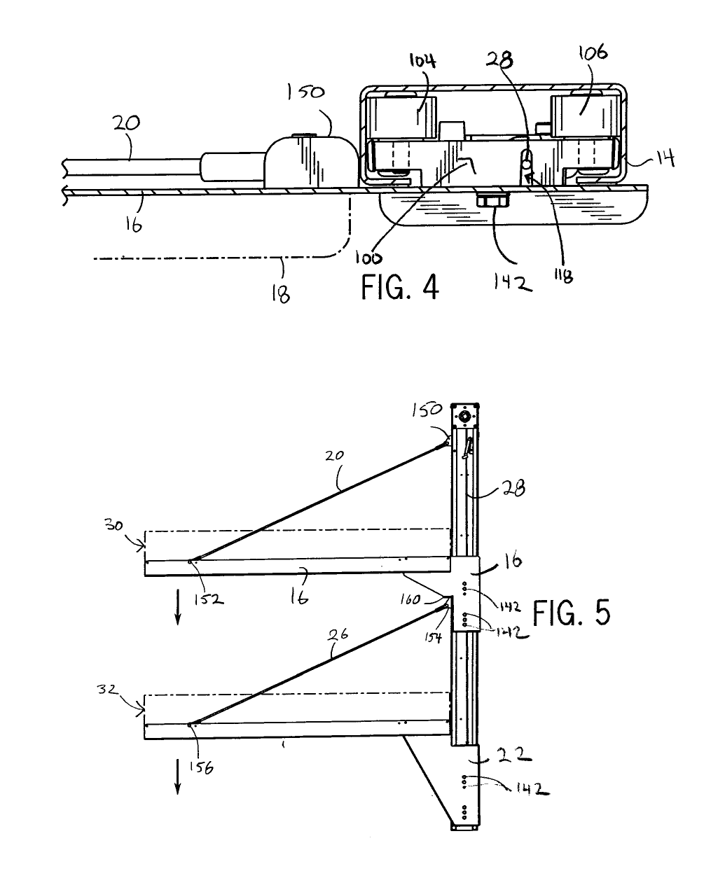

Referring now to FIGS. 1, 2, 12 and 13, a cable spool housing 68 is mounted to each of the top ends of columns 14. Each cable spool housing 68 includes a rotatably mounted cable spool 70. The cable spool housings 68 are mounted to the columns 14 so that the cable spools 70 are positioned within the column channels 34 about an axis that is parallel to an axis that motor brake 60 rotates. A portion of the column rails 42 may be cut out to accept the cable spools 70. The cable spool housings 68 include appropriate hardware to allow for the rotation of the cable spools 70. Cable spools 70 include drive shaft elements 72. The cable spool housings 68 and/or cable spools 70 may include anti-backsplash plates to prevent cable tangling. Cables 28 could be replaced with chains or any tension members capable of supporting the platforms.

A drive assembly mount 74 is attached to one of the columns 14. The drive assembly 12 is mounted to drive assembly mount 74 so that the shaft end of the gear box output shaft 66, which is the shaft end oriented towards the column 14 to which the drive assembly 12 is mounted, is coupled to the drive shaft element 72 of the cable spool 70 mounted to the column 14 to which the drive assembly 12 is mounted. Hence, rotation of the motor brake 60 is transmitted to the cable spool 70 mounted to the column 14 to which the drive assembly 12 is mounted. A drive shaft 76 extends between and is coupled to the shaft end of the gear box output shaft 66 oriented away from the column 14 to which the drive assembly 12 is mounted and to the drive shaft element 72 of the cable spool 70 mounted to the column to which the drive assembly 12 is not mounted. Rotational of the motor brake 60 is thereby transmitted to the cable spool 70 mounted to the column 14 to which the drive assembly 12 is not mounted. Hence, both cable spools 70 rotate with the same angular velocity.

The shaft ends of the gear box output shaft 66, the drive shaft elements 72, and the drive shaft 76 may be of any suitable shape and/or combination of shapes for coupling the elements together (e.g., square, round). Couplers and/or adapters may be used to couple together any of the shaft ends of the gear box output shaft 66, the drive shaft elements 72, and the drive shaft 76. Drive shaft elements 72 of cable spools 70 can be accessible for manual rotation in case of a motor brake 60 malfunction.

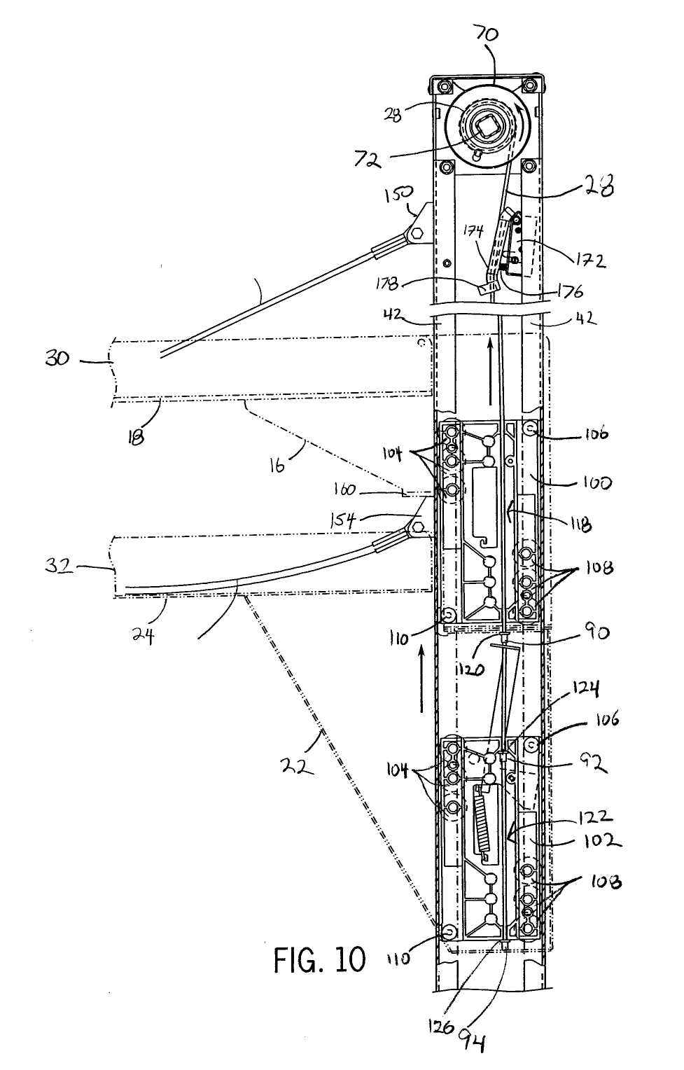

Referring now to FIG. 10, one cable 28 is attached to and configured to be wound around each cable spool 70. An upper catch device 90, a first lower catch device 92 and a second lower catch device 94 are fixedly attached to each cable 28. Catch devices 90, 92 and 94 comprise a cylindrical portion and a flange portion. As shown in FIG. 12, in another embodiment, each cable 28 may include only an upper catch device 90. Catch devices 90, 92, and 94 can comprise any other suitable device that serves as a cable stop (e.g., catch device 90 of FIG. 12). Rotational movement of the cable spools 70 cause cables 28 to move vertically; therefore, drive assembly 12 can cause cables 28 and attached catch devices 90, 92, and 94 to move vertically.

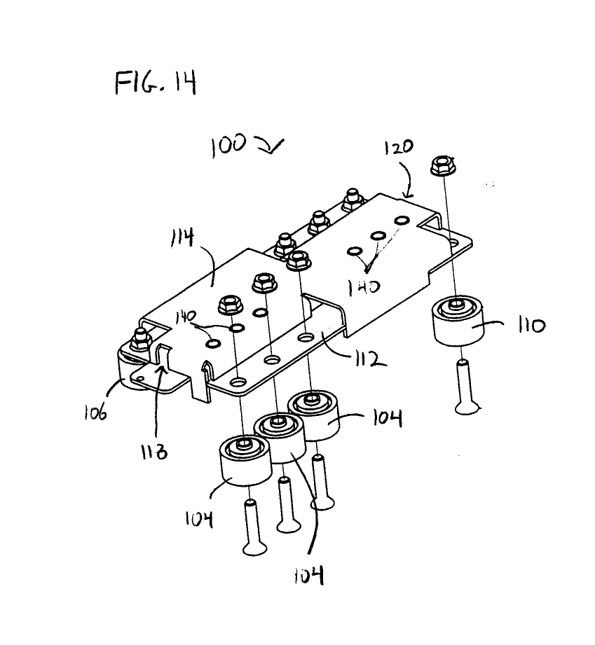

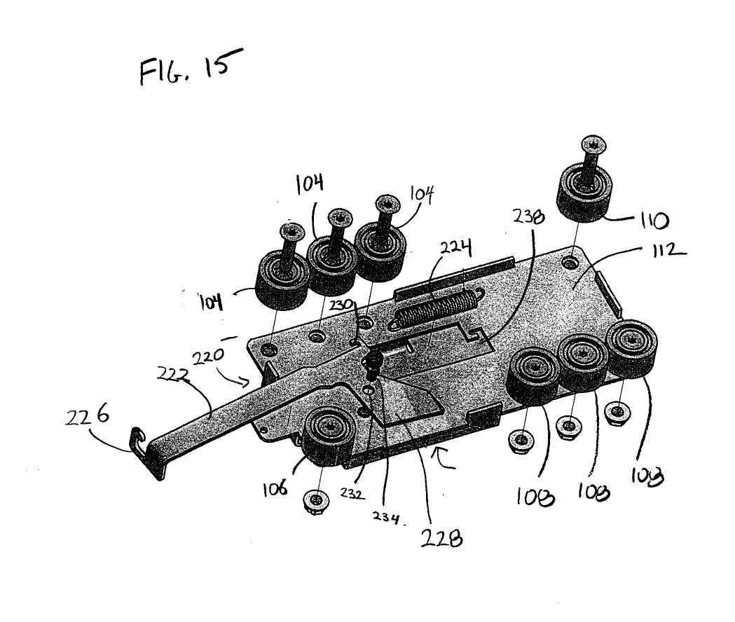

Referring now to FIGS. 10, 12, 14 and 15, an upper truck 100 and a lower truck 102 are configured to roll within the column channels 34. Trucks 100 and 102 include an upper set of wheels 104, an upper wheel 106, a lower set of wheels 108, a lower wheel 110, a truck body 112 and a truck cover 114. Upper set of wheels 104 includes three wheels attached to the truck body 112 along a side edge of truck body 112 towards a top portion of truck body 112 so that the upper set of wheels 104 roll along the channel second side wall 40 when the truck is positioned within the column channel 34. Upper wheel 106 is attached to the truck body 112 on a side edge opposite to the upper set of wheels 104 and towards a top portion of truck body 112 so that the upper wheel 106 rolls along the channel first side wall 38 when the truck is positioned within the column channel 34. Lower set of wheels 108 includes three wheels attached to the truck body 112 along a side edge of truck body 112 towards a bottom portion of truck body 112 so that the lower set of wheels 108 roll along the channel first side wall 38 when the truck is positioned within the column channel 34. Upper wheel 110 is attached to the truck body 112 on a side edge opposite to the lower set of wheels 108 and towards a bottom portion of truck body 112 so that the lower wheel 110 rolls along the channel second side wall 40 when the truck is positioned within the column channel 34.

Referring specifically to FIG. 10, each upper truck 100 includes a channel 118 sized to allow cable 28 to vertically run through the upper truck 100. At a bottom portion 120 of channel 118, upper truck 100 is sized to prohibit cable catch device 90 from fitting through channel 118. Thus, the catch device 90 can support upper truck 100 when cable 28 is run through upper truck 100 and upper truck 100 rests upon catch device 90. Cable 28 can freely move through the upper truck 100 when the upper truck 100 does not rest upon catch device 90. Upper trucks 100 rest upon catch devices 90 except when in the ready position. Each lower truck 102 includes a channel 122 sized to allow cable 28 to vertically run through the lower truck 102. At a top portion 124 of channel 122, lower truck 102 is sized to prohibit cable catch 92 from fitting through channel 122. Likewise, at a lower portion 126 of channel 122, lower truck 102 is sized to prohibit cable catch 94 from fitting through channel 122. The catch devices 92 and 94 can support lower truck 102 when cable 28 is run through lower truck 102 and the lower truck 102 rests upon the catch devices 92 and 94. Hence, trucks 100 and 102 can be moved vertically within column channels 34 when drive assembly 12 causes cables 28 (along with catch devices 90, 92 and 94) to move vertically.

Referring to FIG. 1, upper truck brace 16 is attached to upper truck 100 and lower truck brace 22 is attached to lower truck 102. Trucks 100 and 102 include a plurality of holes 140 and truck braces 16 and 22 include a plurality of holes (not shown) through which a plurality of fasteners 142 attach truck braces 16 and 22 to trucks 100 and 102. Truck braces 16 and 22 can be bolted, welded and/or otherwise fastened to trucks 100 and 102. Upper support arm 18 is attached to upper truck brace 16 and lower support arm 24 is attached to lower truck brace 22. Support arms 18 and 24 can be bolted, welded and/or fastened to truck braces 16 and 22. Upper support arms 18 support upper platform 30 and lower support arms 24 support lower platform 32. Platforms 30 and 32 can be bolted, welded and/or fastened to support arms 18 and 24. Hence, platforms 30 and 32 are cantilevered from the columns 14. Support arms 18 and 24 are L-shaped beams but may be otherwise configured to support platforms 30 and 32 and to be attach to braces 16 and 22. Truck braces 16 and 22, support arms 18 and 24, and platforms 30 and 32 are moved vertically along column channels 34 when trucks 100 and 102 are moved by drive assembly 12. Platforms 30 and 32 are substantially parallel and remain substantially parallel when moved.

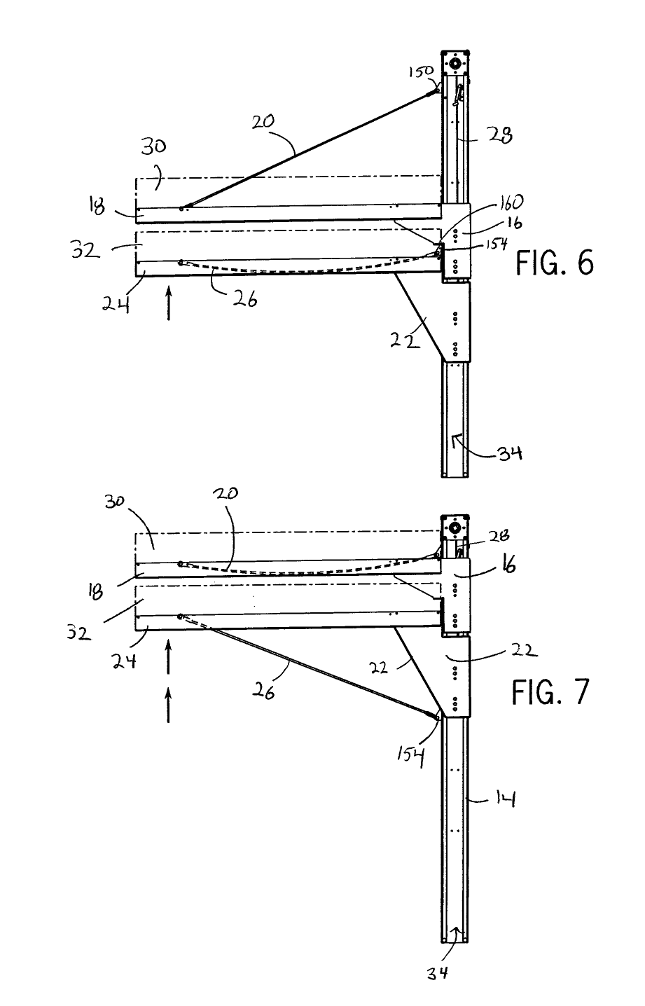

Referring now to FIGS. 1 and 5, upper support members 20 provide additional support to upper platform 30 when platform lift 10 is in a ready position (shown in FIGS. 1 and 5). Each upper support member 20 is attached between an upper portion of one of columns 14 and a distal portion of the nearest upper support arm 18. Each column 14 includes a mounting flange 150 to which upper support member 20 is bolted (as shown in the Figs.), welded and/or otherwise fastened. Each mounting flange 150 extends from one of the columns 14 on the second side wall 40 side of the column 14 in a direction towards platforms 30 and 32. Mounting flanges are tabbed and welded to the columns 14 but can be otherwise fastened to the columns 14. A bolt 152 fastens upper support member 20 to upper support arm 18 but upper support member 20 can be otherwise fastened to upper support arm 18. Upper support members 20 are cables and are configured to allow upper support arms 16 to move between a ready position (shown in FIGS. 1 and 5) and a stowed position (shown in FIG. 6). Upper support members 20 could be chains, pivotally attached slotted bars or other support structure configured to allow for upper support arms 16 to move between the ready and stowed positions. Lower support members 26 provide additional support to lower platform 32 when platform lift 10 is in a ready position (shown in FIGS. 1 and 5). Each lower support member 26 is attached between a mid portion of one of columns 14 and a distal portion of the nearest lower support arm 24. Each column 14 includes a mounting flange 154 to which lower support member 26 is bolted, welded and/or otherwise fastened. Each mounting flange 154 extends from the one of the columns 14 on the second side wall 40 side of the column 14 in a direction towards platforms 30 and 32. Mounting flanges 154 are tabbed and welded to the columns 14 but can be otherwise fastened to the columns 14. Mounting flanges 154 have an upper edge that is wider than a lower edge. A bolt 156 fastens lower support member 26 to lower support arm 24 but lower support member 26 can be otherwise fastened to lower support arm 24. Lower support members 26 are cables and allow lower support arms 24 to move between a ready position (shown in FIGS. 1 and 5) and a stowed position (shown in FIG. 6). Lower support members 26 can alternatively be chains, pivotally attached slotted bars or other support structures configured to allow for lower support arms 24 to move between the ready and stowed positions. The orientation of the flanges 150 and 154 is preferably as illustrated in FIGS. 12 and 13.

Referring now to FIGS. 1, 5 and 10, upper truck braces 16 are configured to rest upon mounting flanges 154 in the ready position. FIG. 5 shows that the upper truck braces 16 each have a rectangular portion sized to overlie the upper truck 100 and a substantially triangular portion that extends from the rectangular portion in an upward direction towards platforms 30 and 32. A rest tab 160 extends from each upper truck brace 16 at a lower vertex of the substantially triangular portion adjacent the rectangular portion. Rest tabs 160 are rectangular and can be cut from upper truck brace 16 and bent until they are perpendicular to a face of truck brace 16. Rest tabs 160 extend from upper truck braces 16 in a direction towards the nearest column 14. When the upper truck braces 16 (and the upper trucks 100, upper support members 18, and upper platform 30) are lowered into the ready position, each rest tab 160 engages one of mounting flanges 154 thereby stopping the upper truck braces 16 from being further lowered (shown in FIG. 10). Upper truck braces 16 sit on the mounting flanges 154 in the ready position, the mounting flanges 154 supporting the upper truck braces 16, upper trucks 100, upper support members 18, and upper platform 30. Cables 28 and upper catch devices 90 can be further lowered so that the upper trucks 100 do not sit upon catch devices 90 because cables 28 can freely move through the upper trucks 100 when the upper trucks do not rest upon the upper catch devices 90. Cables 28 do not support the upper platform 30 in the ready position. When upper catch devices 90 are raised from a position below where catch devices 90 engage the upper trucks 100, the upper catch devices 90 catch upper trucks 100 and lift the upper trucks 100 thereby lifting the upper truck braces 16 off of the mounting flanges 154. Lower truck braces 22 are configured to not engage the mounting flanges 154.

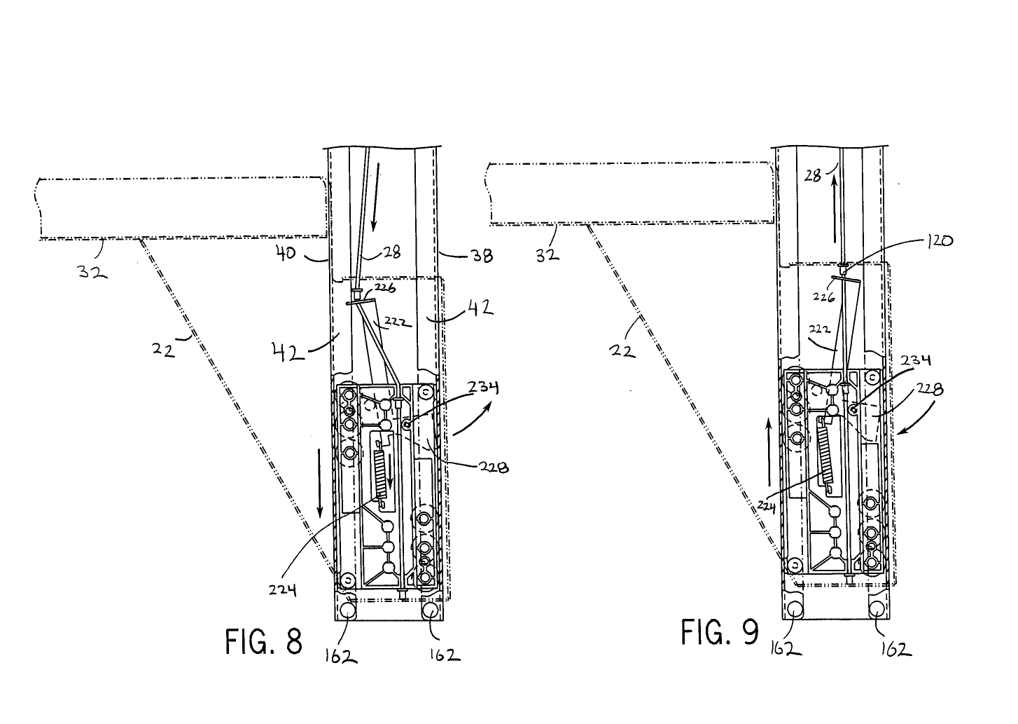

Referring now to FIGS. 1, 8, 9 and 12, a pair of stop pins 162 extend from each column 14. One stop pin 162 extends from each rail 42 of the columns 14 at a lower end of the columns 14 and in a direction away from the column 14. Stop pins 162 can be tabbed and welded or otherwise attached to the columns 14 from lower truck braces 22 are configured to rest up upon stop pins 162 in the ready position (shown in FIG. 8). When the lower truck braces 22 (and the lower trucks 102, lower support members 20, and upper platform 22) are lowered into the ready position, a lower edge of each of the truck braces 22 engages the stop pins 162 thereby stopping the lower truck braces 22 from being further lowered (shown in FIG. 10). Lower truck braces 22 sit on the stop pins 162 in the ready position, the stop pins 162 supporting the lower truck braces 22, lower trucks 102, lower support members 24, and lower platform 32. Cables 28 and lower catch devices 92 and 94 can be further lowered so that the lower trucks 102 do not sit upon catch devices 92 and 94 thereby allowing the cables 28 to go slack. Cables 28 do not support the lower platform 32 in the ready position.

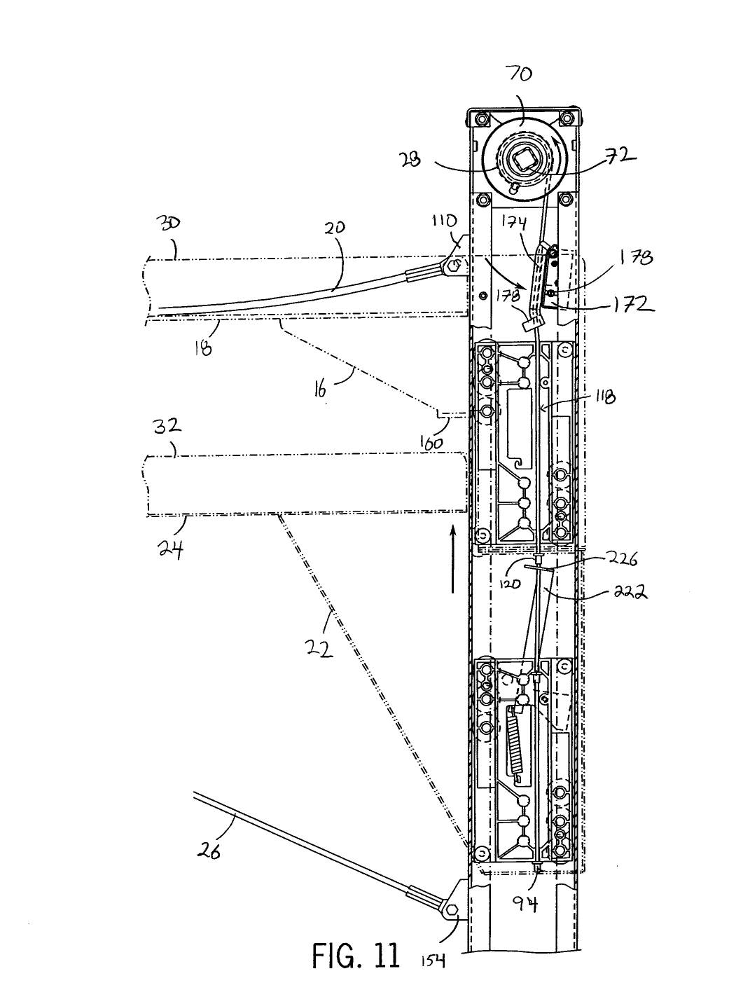

Referring now to FIGS. 10 and 11, a slack cable sensor 170 is configured to monitor a slackness of one of cables 28 and cause motor brake 60 to shut off when the monitored cable goes slack. At least one slack cable sensor 170 is mounted within channel column 36 of each column 14 and monitors the slackness of the cable associated with the column. Slack cable sensor 170 includes a sensor body 172, sensor arm 174, spring 176 and limit switch 178. Sensor body 172 is attached to an inner face of channel first side wall 38. A proximal end of sensor arm 174 is pivotally attached to sensor body 172 at an upper portion of sensor body 172. Sensor arm 174 includes a sensor arm head 180 at a distal portion of the sensor arm 174. Spring 176 is configured to bias sensor arm 174 away from sensor body 172, spring 176 being positioned between a lower portion of sensor body 172 and a distal portion of sensor arm 174. Sensor body 172 is positioned within channel 36 of column 14 and mounted to column 14 so that sensor arm head 180 is biased against cable 28 by spring 176. Sensor body 172 is configured to protect the limit switch 178 from being damaged by cable 28 when cable 28 is taught. When cable 28 goes slack, sensor arm head 180 and sensor arm 174 move away from sensor body 172 thereby switching limit switch 178. Limit switch 178 is electrically connected to the platform lift control system (not shown) that causes motor brake 60 to stop when limit switch 178 indicates that the cable 28 has become slack.

Referring now to FIG. 12 and 13, according to another embodiment, a slack sensor 190 is configured to monitor a slackness of one of cables 28 and cause motor brake 60 to shut off when the monitored cable goes slack. Slack sensor 190 includes a sensor housing 192, a limit switch 194, a sensor arm 196 and a spring 198. Sensor housing 192 is attached to an outer face 200 of channel first side wall 38. An opening 202 is formed in channel first side wall 38. Sensor arm 196 is pivotally attached to sensor housing at a pivot point 204. Sensor arm 196 extends through opening 202 into channel column 36. Sensor arm 196 includes a sensor arm head 206 that is positioned within channel column 36. Spring 198 is attached between sensor housing 192 and sensor arm 196, spring 198 biasing sensor head 206 against cable 28. When cable 28 goes slack, sensor arm head 206 moves away from limit switch 194 thereby switching limit switch 194. Limit switch 194 is electrically connected to the platform lift control system (not shown) that causes motor brake 60 to stop when the limit switch 194 indicates that the cable 28 has become slack.

Platform lift 10 is configured so that the upper platform 30, upper truck braces 16, upper support arms 18, and upper trucks 100 do not engage the slack sensor 170 (as shown in FIG. 11). Platform lift 10 is configured so that so that the lower platform 32, lower truck braces 22, lower support arms 24 and lower trucks 102 do not engage any of the upper platform 30, upper truck braces 16, upper support arms 18, and upper trucks 100 in the stowed position (as shown in FIGS. 7 and 11). Platform lift 10 is configured so that the lower support members 26 prevent the lower support arm 24 from being further raised to a position above the stowed position (as shown in FIGS. 7 and 11); therefore, cables 28 are prevented from being raised to a position above the stowed position.

The platform lift controls further include a switch (not shown) and a current sensor (not shown). The switch and current sensor are configured to control the operation of motor brake 60. The switch can be a rocker switch with up, down and off positions. The current sensor can be a shunt resistor or hall effect type current sensor, or any other type commonly used in motor control circuits. The current sensor is configured to sense the current drawn by the motor brake 60 and cause the motor brake 60 to stop when the current drawn by the motor brake 60 goes above a threshold level. The current drawn by the motor brake 60 can go above the threshold level when the motor brake 60 attempts to cause the movement of cables 28 that are prevented from further movement in that direction. When the platform lift 10 is in the stowed position and the switch is thereafter activated, the motor brake 60 causes the cables to be lowered until at least one slack sensor 190 indicates that one of the cables 28 has gone slack. As discussed hereinabove, the cables 28 go slack when the lower platform 32 is supported by the stop pins 162 and the cables 28 are further lowered so that the cables 28 no longer support the lower platform 32 (i.e., when the lower platform 32 is in the ready position). When the platform lift 10 is in the ready position and the switch is thereafter activated, the motor brake 60 causes the cables 28 to be raised until the current sensor senses that the motor brake 60 is attempting to cause the movement of cables 28 that are blocked from further upward movement. As discussed hereinabove, the cables 28 are prevented from further upward movement when lower support members 26 prevent the lower support arm 24 from being further raised (i.e., when the lower platform 32 is in the stowed position).

In another embodiment of the platform lift, the platform control system can include a controller that senses location information about platform lift 10 and uses that information to control drive assembly 12. For example, a sensor could monitor the rotations of motor brake 60 and calculate the position of platforms 30 and 32. A linear displacement sensor could monitor the length of cable 28 or the height of platforms 30 and 32. The platform lift can also include limit switches configured to engage the trucks and shut off motor brake 60 at the ends of travel (e.g., a limit switch that is switched when a platform reaches the ready position and a limit switch that is switched when a platform reaches the stowed position).

Referring now to FIGS. 8, 9, and 15, each lower truck 102 can include a brake assembly 220 configured to brake the vertical motion of the lower truck 102 when the cable 28 that is associated with the lower truck 102 goes slack. Brake assembly 220 includes a brake arm 222 and a spring 224. Brake arm 222 includes a cable grab 226, a brake head 228 and a spring catch 230. Brake head 228 extends substantially perpendicularly from brake arm 222 and includes a pivot hole 232. A fastener 234 extends through pivot hole 232 and attaches to lower truck body 112 and, thus, brake arm 222 is pivotally attached to lower truck body 112. Lower truck 102 includes a slot 236 sized so that brake head 228 can fit through slot 236. Brake arm 222 is mounted to lower truck body 112 so that brake head 228 can be moved between a brake head retracted position (shown in FIGS. 9 and 15) and a brake head extended position (shown in FIG. 8). In the brake head retracted position, brake head 228 is positioned within lower truck 102 and does not extend through slot 236. In the brake head extended position, at least a portion of brake head 228 extends through slot 236 and, thus, out of lower truck 102. Spring 224 is connected between brake arm spring catch 230 and a spring catch 238 of lower truck body 112. Brake arm spring catch 230 and brake head 228 are positioned on opposite sides of pivot hole 232. Spring 224 biases brake arm 222 so that brake head 228 is in the brake head extended position. When lower truck 102 is installed in one of the columns 14 of platform lift 10, cable grab 226 is positioned around one of cables 28. Spring 224 biases brake arm 222 against cable 28 in a direction towards channel second side wall 40. When cable 28 is taught, the spring force exerted by brake arm 222 against cable 28 is not large enough to overcome the tensile force of cable 28 (shown in FIG. 9) and, thus, brake head 228 is in the spring head retracted position. When cable 28 becomes slack, the spring force exerted by brake arm 22 against 28 is large enough to cause cable 28 to move horizontally and, thus, brake head 228 pivots into the brake head extended position (shown in FIG. 8). Brake head 228 moves in a direction towards slots 44 of channel first side wall 38. Slots 44 are sized to allow at least a portion of brake head 228 to extend through slots 44. Slots 44 are positioned along a length of travel of brake head 228 along column 14. When the brake head 228 moves into the brake head extended position, at least a portion of brake head 228 either extends through one of slots 44 or brake head 228 extends against channel first side wall 38 until lower truck 102 moves further down so as to allow at least portion of brake head 228 to extend through one of slots 44. When at least a portion of brake head 228 extends through one of slots 44, a portion of brake head 228 rests against a lower side of one of slots 44 so that brake head 228 prevents lower truck 102 from moving; therefore, lower platform 32 is prevented from moving when cable 28 goes slack. Cable 28 can go slack when there is a malfunction and/or cable break; therefore, brake assembly 220 can prevent and/or arrest lower platform 32 from further falling during a malfunction and/or cable brake. When lower platform 32 is halted by the brake assembly 220 during a malfunction and/or cable break, upper platform 30 can be supported by lower platform 32. Upper trucks 100 can also include a brake assembly.

It should be appreciated that merely a preferred embodiment of the invention has been described above. However, many modifications and variations to the preferred embodiment will be apparent to those skilled in the art, which will be within the spirit and scope of the invention. Therefore, the invention should not be limited to the described embodiment. To ascertain the full scope of the invention, the following claims should be referenced.

1. A platform lift for a vehicle, the platform lift comprising at least a first platform suspended by a plurality of tension members and guided by a plurality of columns so that the first platform is movable vertically between a first platform stowed position and a first platform ready position, the improvement wherein all of the columns guiding the platform are to one side of a center of the first platform.

2. The improvement of claim 1, wherein the first platform is supported by the plurality of tension members and cantilevered from the columns in at least one position of the first platform along the columns.

3. The improvement of claim 2, wherein the first platform is fully supported by the plurality of tension members and the cantilevering from the columns in the stowed position.

4. The improvement of claim 1, wherein a first support member is attached to the first one of the columns and to the first platform and a second support member is attached to the second one of the columns and to the first platform, the first and second support members partially supporting the first platform in the ready position.

5. The improvement of claim 4, wherein the plurality of tension members does not support the first platform in the ready position.

6. The improvement of claim 1, wherein the platform lift further comprises a first truck and a second tuck, the first truck rolling along a first one of the columns and the second truck rolling along a second one of the columns, the first platform extending from the first and second trucks.

7. The improvement of claim 6, wherein a plurality of notches are formed within the first one of the columns and the first truck includes a fall protection assembly, the fall protection assembly configured to engage at least one of the plurality of notches if one of the plurality of tension members goes slack in a position of the first platform that is between the stowed and ready positions of the first platform.

8. The improvement of claim 1, wherein the platform lift further comprises a motor and a first slack tension member sensor, the motor causing the plurality of tension members to vertically move the first platform and the first slack tension member sensor monitoring a slackness of at least one of the plurality of tension members, the first slack tension member sensor causing the motor to stop when the one of the plurality of tension members goes slack.

9. The improvement of claim 8, wherein the first slack tension member sensor comprises a limit switch and a sensor arm, the limit switch connected to the motor and the sensor arm biased against the one of the plurality of tension members and configured to switch the limit switch when the one of the plurality of tension members goes slack.

10. The improvement of claim 8, wherein the platform lift further comprises a second slack tension member sensor that monitors a slackness of another of the plurality of tension members, the second slack tension member sensor causing the motor to stop when the other of the plurality of tension members goes slack.

11. The improvement of claim 1, wherein the platform comprises two columns.

12. The improvement of claim 14, wherein the two columns are to a side of the first platform.

13. The improvement of claim 1, wherein the platform lift further comprises a second platform vertically movable between a second platform stowed position and a second platform ready position, a pair of first trucks with the first platform extending therefrom, and a pair of second trucks with the second platform extending therefrom, wherein the plurality of tension members include a plurality of first truck catch members and a plurality of second truck catch members, the plurality of first truck catch members supporting the pair of first trucks when the first platform is positioned at a height above the first platform ready position and the plurality of second truck catch members supporting the pair of second trucks when the second platform is positioned at a height above the second platform ready position.

14. The improvement of claim 13, wherein the second platform does not support the first platform when the second platform is in the second platform stowed position.

15. The improvement of claim 13, wherein the platform lift further comprises a pair of first braces, a pair of second braces, a plurality of first stops, and a plurality of second stops, each one of the pair of first braces attached to one of the pair of first trucks and to the first platform and each one of the pair of second braces attached to one of the pair of second trucks; wherein the first stops prevent the pair of first braces from being lowered below a first brace ready position but do not prevent the pair of second braces from being lowered below a first brace ready position and the second stops prevent the pair of second trucks from being lowered below a pair of second trucks ready position.
